(19) United States
(12) Patent Application Publication
(10) Pub. No.: US 2013/0186672 A1
(43) Pub. Date: Jul. 25, 2013

(54) METAL FILM MATERIAL AND METHOD FOR MANUFACTURING THE SAME

(71) Applicant: Fujifilm Corporation, Tokyo (JP)

(72) Inventors: Toshihiro KARIYA, Ashigarakami-gun (JP); Seishi KASAI, Ashigarakami-gun (JP); Mitsuyuki TSURUMI, Ashigarakami-gun (JP)

(73) Assignee: FUJIFILM CORPORATION, Tokyo (JP)

(21) Appl. No.: 13/792,250

(22) Filed: Mar. 11, 2013

Related U.S. Application Data
(63) Continuation of application No. PCT/JP2011/065618, filed on Jul. 7, 2011.

(30) Foreign Application Priority Data
Sep. 29, 2010 (JP) 2010-219421

(51) Int. Cl. B05D 7/14

(52) U.S. Cl. CPC B05D 7/14
USPC 174/133 R; 427/511; 427/58

(57) ABSTRACT

The present invention provides a method for manufacturing a metal film material, the method including: applying an ink composition by discharging the ink composition onto a substrate via an inkjet method, the ink composition containing at least one first monomer having at least one group selected from the group consisting of a cyano group, an alkyloxy group, an amino group, a pyridine residue, a pyrrolidone residue, an imidazole residue, an alkylsulfanyl group, or a cyclic ether residue, at least one second monomer that has polyfunctionality, and at least one polymerization initiator, a total monomer content in the ink composition being 85% by mass or greater; forming a cured film by carrying out at least one of light exposure or heating of the ink composition that has been applied; applying a plating catalyst or a precursor thereof to the cured film; and a plating processing step of performing plating with respect to the plating catalyst or precursor thereof that has been applied.

### CROSS-REFERENCE TO RELATED APPLICATIONS

This application is a continuation application of International Application No. PCT/JP 2011/065618, filed Jul. 7, 2011, which is incorporated herein by reference. Further, this application claims priority from Japanese Patent Application No. 2010-219421, filed Sep. 29, 2010, which is incorporated herein by reference.

### TECHNICAL FIELD

The present invention relates to a metal film material and a method for manufacturing the same.

### BACKGROUND ART

A substrate having a metal film on a surface thereof (a metal-plated material; hereinafter, also referred to as a “metal film material”) has been used as a metal wiring board that wires electronic parts, semiconductor elements, or the like. Further, in general, formation of a desired metal pattern (a conductive pattern) has been carried out by performing pattern-wise etching of the metal film on the surface of the metal film material using a treatment liquid.

As to a method for manufacturing the metal film material, the formation of a metal film by providing a polymer layer on a substrate and performing plating on this polymer layer has been studied. As one example of the above-described method for manufacturing a metal film material, a technique of using a mixture of a polymer and a monomer for the polymer layer and introducing a group that causes an interaction with a metal into at least one of the polymer or the monomer to improve the adhesion between the substrate and the metal film has been disclosed (see, for example, Japanese Patent Application Laid-Open (JP-A) No. 2009-263707).

Further, as a technique for improving the adhesion between the metal pattern formed and the substrate or improving the insulating property of the metal pattern formed, a technique of applying a composition for forming an electroless plated pattern, the composition including a (meth)acrylate compound and a chelating agent, onto a base material by an inkjet method has been disclosed (see, for example JP-A No. 2004-353027).

### SUMMARY OF INVENTION

### Technical Problem

However, with respect to the above techniques, studies aiming to improve productivity have not been carried out. Specifically, no studies have been made with a view to improving the ejection stability (hereinafter, may also be referred to as “ejection recoverability after being left to stand”) in a case in which ejection of an ink composition using an inkjet recording apparatus is suspended, the inkjet recording apparatus is left standing for a certain period, and then the ejection is resumed.

Further, with the above techniques, no studies have been made with a view to improving the etching resistance of the metal film material, that is, the solubility resistance of an undercoat layer that faces the metal film (for example, the polymer layer in JP-A No. 2009-263707) with respect to an etching processing liquid, so as to improve the accuracy of the pattern shape of the metal pattern to be formed, and therefore, further improvement is required.

The present invention has been made in view of the above problems and aims to provide a method for manufacturing a metal film material, with which an excellent effect on the ejection stability (ejection recoverability after being left to stand) is obtained in a case in which ejection of an ink composition using an inkjet recording apparatus is suspended, the inkjet recording apparatus is left standing for a certain period, and then the ejection is resumed, and also a high etching resistance is realized so that the accuracy of the pattern shape to be obtained can be enhanced; and a metal film material obtained by using the method.

### Solution to Problem

Specific means for achieving the above objects are as described below.

<1> A method for manufacturing a metal film material, the method including: an ink application step of applying an ink composition by discharging the ink composition onto a substrate via an inkjet method, the ink composition containing at least one first monomer having at least one group selected from a cyano group, an alkyloxy group, an amino group, a pyridine residue, a pyrrolidone residue, an imidazole residue, an alkylsulfanyl group, or a cyclic ether residue, at least one second monomer that has polyfunctionality, and at least one polymerization initiator, a total monomer content in the ink composition being 85% by mass or greater; a cured film forming step of forming a cured film by carrying out at least one of light exposure or heating of the ink composition that has been applied; a catalyst application step of applying a plating catalyst or a precursor thereof to the cured film; and a plating processing step of performing plating with respect to the plating catalyst or precursor thereof that has been applied.

<2> The method for manufacturing a metal film material according to <1>, wherein the at least one first monomer includes a monofunctional monomer.

<3> The method for manufacturing a metal film material according to <1> or <2>, wherein the at least one first monomer includes a monomer represented by the following Formula (M1-1).

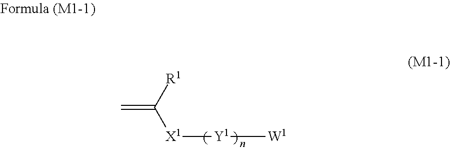

In Formula (M1-1), R¹ represents a hydrogen atom, or a substituted or unsubstituted alkyl group. X¹ and Y¹ each independently represent a single bond, or a substituted or unsubstituted divalent organic group. W¹ represents a cyano group, an alkyloxy group, an amino group, a pyridine residue, a pyrrolidone residue, an imidazole residue, an alkylsulfanyl group, or a cyclic ether residue. n represents an integer of from 1 to 3, and when n is 2 or greater, plural instances of Y¹ may be the same as or different from each other.

<4> The method for manufacturing a metal film material according to any one of <1> to <3>, wherein the content of the at least one second monomer is from 1% by mass to 20% by mass with respect to the total amount of monomers included in the ink composition.

<5> The method for manufacturing a metal film material according to any one of <1> to <4>, wherein the content of the at least one first monomer is from 10% by mass to 80% by mass with respect to the total amount of monomers included in the ink composition.

<6> The method for manufacturing a metal film material according to any one of <1> to <5>, wherein the content of the at least one polymerization initiator is from 1% by mass to 15% by mass with respect to the total amount of the ink composition.

<7> The method for manufacturing a metal film material according to any one of <1> to <6>, wherein a content of polymerizable groups included in the at least one second monomer is from 0.5 mmol/g to 2.0 mmol/g, with respect to the total amount of the ink composition.

<8> The method for manufacturing a metal film material according to any one of <1> to <7>, wherein a content of polymer compounds having a molecular weight of equal to or greater than 1500 in the ink composition is 2.5% by mass or less.

<9> The method for manufacturing a metal film material according to any one of <3> to <8>, wherein, in Formula (M1-1), R¹ represents a hydrogen atom or a methyl group, X¹ represents —COO— or —CONH—, and Y¹ represent an alkylene group having from 1 to 3 carbon atoms.

<10> The method for manufacturing a metal film material according to any one of <1> to <9>, wherein the at least one second monomer includes a polyfunctional monomer having two or more groups selected from the group consisting of acrylate groups, methacrylate groups, acrylamido groups, methacrylamido groups, vinyloxy groups, and N-vinyl groups.

<11> The method for manufacturing a metal film material according to any one of <1> to <10>, wherein the cured film forming step is carried out in an environment having an oxygen concentration of 10% or less.

<12> The method for manufacturing a metal film material according to any one of <1> to <11>, wherein, in the ink application step, the ink composition is discharged onto the substrate pattern-wise.

<13> A metal film material obtained by the method for manufacturing a metal film material according to any one of <1> to <12>.

### Advantage Effects of Invention

According to the present invention, a method for manufacturing a metal film material, with which an excellent effect on the ejection stability (ejection recoverability after leaving), in a case in which ejection of an ink composition by using an inkjet recording apparatus is suspended, and the inkjet recording apparatus is left for a certain period, and then the ejection is resumed, is obtained and also a high etching resistance is realized so that the accuracy of the pattern shape to be obtained can be enhanced, and a metal film material obtained by the use of the above method may be provided.

### DESCRIPTION OF EMBODIMENTS

Hereinafter, a method for manufacturing a metal film material and a metal film material of the present invention are described in detail.

The method for manufacturing a metal film material of the present invention includes an ink application step (A) of applying a specific ink composition onto a substrate by an inkjet method, a cured film forming step (B) of forming a cured film by carrying out at least one of light exposure or heating of the ink composition that has been applied, a catalyst application step (C) of applying a plating catalyst or a precursor thereof to the cured film, and a plating processing step (D) of performing plating with respect to the plating catalyst or precursor thereof that has been applied.

Further, the metal film material of the present invention is a metal film material which is obtained by the above-described method for manufacturing a metal film material of the present invention.

In the following, first, the ink composition used in the present invention is described in detail. Details of the respective steps in the manufacturing method are described below.

Note that, in the present specification, the term “(meth)acrylate” refers to at least one of acrylate or methacrylate.

<Ink Composition>

The ink composition (hereinafter, may also be referred to as, simply, “ink”) in the present invention is a so-called ink composition for inkjet recording, and includes at least one first monomer having at least one group selected from a cyano group, an alkyloxy group, an amino group, a pyridine residue, a pyrrolidone residue, an imidazole residue, an alkylsulfanyl group, or a cyclic ether residue, at least one second monomer that has polyfunctionality, and at least one polymerization initiator, and the total monomer content in the ink composition is 85% by mass or greater. Further, the ink composition in the present invention may further include other components, as necessary.

Here, the “the total monomer content” indicates the total content of the at least one first monomer, the at least one second monomer, and at least one third monomer which is used as needed and is described below.

According to the method for manufacturing a metal film material of the present invention, by using an ink composition having such a configuration, excellent ejection stability (ejection recoverability after leaving), in a case in which ejection of the ink composition using an inkjet recording apparatus is suspended, and the inkjet recording apparatus is left for a certain period, and then the ejection is resumed, may be obtained and also the etching resistance of the metal film material obtained may be improved. By improving the etching resistance of the metal film material, deformation of the shape during pattern formation may be suppressed, and a high accuracy pattern may be formed.

In the method for manufacturing a metal film material of the present invention, the ink composition has excellent ejection stability, not only after leaving as described above.

The mechanism of the invention is not clear but it is thought that, since the ink composition according to the present invention includes, in addition to a polymerization initiator, plural kinds of monomers, namely, a first monomer having at least one group selected from a cyano group, an alkyloxy group, an amino group, a pyridine residue, a pyrrolidone residue, an imidazole residue, an alkylsulfanyl group, or a cyclic ether residue, and a second monomer that has polyfunctionality, and also, since the total content of the entire amount of monomers in the ink composition is relatively high and is 85% by mass or greater, the crosslink density can be controlled to be within the optimum range so that a dense cured film can be formed, and thus, the resistance with respect to etching processing that uses an agent or the like can be enhanced.

Further, it is thought that, by setting the total content of the entire amount of monomers in the ink composition to be within a relatively high range, it is possible to minimize the influence of physical change of monomer included in the ink composition, and thus, an excellent effect on the “ejection recoverability after leaving” as described above can be obtained.

(First Monomer)

The first monomer has at least one group selected from a cyano group, an alkyloxy group, an amino group, a pyridine residue, a pyrrolidone residue, an imidazole residue, an alkylsulfanyl group, or a cyclic ether residue. In the present invention, these groups each function as a group that forms an interaction (adsorption) with a plating catalyst or precursor thereof which is to be applied in the catalyst application step (C) described below. Hereinafter, these groups may also be referred to as the “interactive groups”. When the ink composition includes the interactive group, an excellent adhesion with respect to the plating catalyst or precursor thereof described below may be obtained and, as a result, a metal film (plated film) having a sufficient thickness can be obtained at the time of plating processing.

The alkylsulfanyl group (—SR group (wherein R represents an alkyl group)) is preferably an alkylsulfanyl group having from 1 to 4 carbon atoms. Further, preferable examples of the cyclic ether residue may include a furan residue and a tetrahydrofurfuryl group.

Among the above interactive groups, an alkyloxy group (preferably, an alkyloxy group having from 1 to 5 carbon atoms) or a cyano group is more preferable, and a cyano group is even more preferable, in view of having high polarity and having a high adsorption ability (interactivity) to the plating catalyst or precursor thereof.

Further, the first monomer used in the ink composition is preferably a monofunctional monomer: and among monofunctional monomers, a monomer which contains an ethylenically unsaturated bond and has radical polymerizability is more preferable.

More specifically, the first monomer is preferably a monofunctional monomer represented by the following Formula (M1-1).

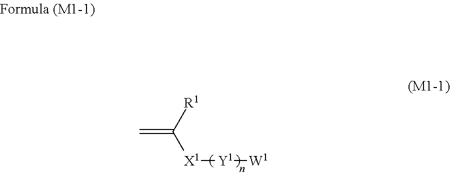

In Formula (M1-1), R¹ represents a hydrogen atom, or a substituted or unsubstituted alkyl group. The substituted or unsubstituted alkyl group represented by R¹ is preferably an alkyl group having from 1 to 4 carbon atoms, and more preferably an alkyl group having from 1 to 2 carbon atoms. More specifically, examples of the unsubstituted alkyl group include a methyl group, an ethyl group, a propyl group, and a butyl group; and examples of the substituted alkyl group include a methyl group, an ethyl group, a propyl group, and a butyl group, each of which is substituted by a methoxy group, a hydroxyl group, a halogen atom (for example, a chlorine atom, a bromine atom, or a fluorine atom), or the like.

R¹ preferably represents a hydrogen atom or a methyl group, and particularly preferably a hydrogen atom.

X¹ and Y¹ each independently represent a single bond, or a substituted or unsubstituted divalent organic group.

Examples of the divalent organic group include a substituted or unsubstituted aliphatic hydrocarbon group (preferably, an aliphatic hydrocarbon group having from 1 to 11 carbon atoms), a substituted or unsubstituted cyclic hydrocarbon group (preferably, a cyclic hydrocarbon group having from 6 to 12 carbon atoms), —O—, —S—, —N(R)— (wherein R represents an alkyl group (preferably an alkyl group having from 1 to 6 carbon atoms, and more preferably an alkyl group having from 1 to 3 carbon atoms)), —CO—, —NH—, —COO—, —CONH—, and a group formed from a combination of these groups (for example, an alkyleneoxy group, an alkyleneoxycarbonyl group, an alkylenecarbonyloxy group, or the like). The divalent organic group may have a substituent such as an alkyl group (preferably, an alkyl group having from 1 to 3 carbon atoms), a hydroxyl group, or the like to the extent of not impairing the effects of the invention.

Examples of the substituted or unsubstituted aliphatic hydrocarbon group (for example, an alkylene group) may include a methylene group, an ethylene group, a propylene group, a butylene group, a pentylene group, a hexylene group, or those obtained by substituting these groups with a methyl group, an ethyl group, a propyl group, a methoxy group, a hydroxyl group, a halogen atom (for example, a chlorine atom, a bromine atom, or a fluorine atom), or the like.

Examples of the substituted or unsubstituted cyclic hydrocarbon group may include a cyclobutylene group, a cyclohexylene group, a norbornylene group, an unsubstituted arylene group (for example, a phenylene group), and a phenylene group substituted by a methoxy group, a hydroxyl group, a halogen atom (for example, a chlorine atom, a bromine atom, or a fluorine atom) or the like.

X¹ preferably represents a single bond, —COO—, or —CONH—, more preferably —COO— or —CONH—, and most preferably —COO—.

Y¹ preferably represents a single bond, a substituted or unsubstituted alkylene group, a cyclic hydrocarbon group, or a group formed from a combination of these groups.

Specific examples of Y¹ may include a substituted or unsubstituted alkylene group (preferably a substituted or unsubstituted alkylene group having from 1 to 6 carbon atoms, and more preferably a substituted or unsubstituted alkylene group having from 1 to 3 carbon atoms), an alkylene oxide group (preferably an alkylene oxide group having from 1 to 4 carbon atoms, and more preferably an alkylene oxide group having from 1 to 2 carbon atoms), and —R—O—R′— (wherein R and R′ each independently represent an alkylene group having from 1 to 3 carbon atoms).

The total number of carbon atoms in Y¹ is preferably from 1 to 6, and more preferably from 1 to 3. Here, the total number of carbon atoms means the total number of carbon atoms included in the substituted or unsubstituted divalent organic group represented by Y¹.

It is preferable that Y¹ represents an unsubstituted group.

n represents an integer of from 1 to 3, and when n is 2 or greater, plural instances of Y¹ may be the same as or different from each other.

W¹ represents at least one group selected from a cyano group, an alkyloxy group, an amino group, a pyridine residue, a pyrrolidone residue, an imidazole residue, an alkylsulfanyl group (an —SR group (wherein R represents an alkyl group)), or a cyclic ether residue.

The preferable range of W¹ is as described above in the explanation of the interactive group. Namely, W¹ preferably represents an alkyloxy group (preferably, an alkyloxy group having from 1 to 5 carbon atoms) or a cyano group, and even more preferably a cyano group.

A preferable combination in Formula (M1-1) is a combination in which R¹ represents a hydrogen atom or a methyl group (more preferably, a hydrogen atom), X¹ represents —COO— or —CONH— (more preferably, —COO—), and Y¹ represents an alkylene group having from 1 to 3 carbon atoms. Further, a combination in which n=1 and W¹ represents a cyano group in the above combination is particularly preferable.

Specific examples of the first monomer include the compounds shown below.

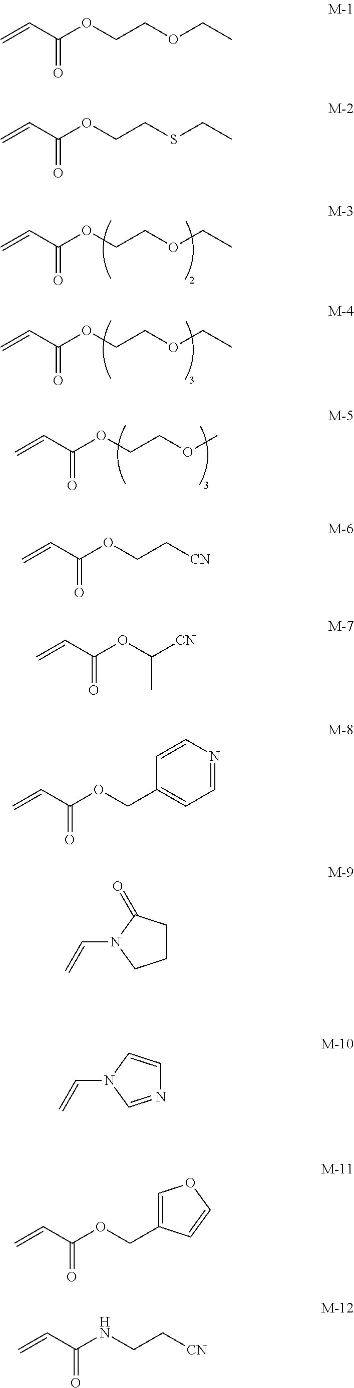

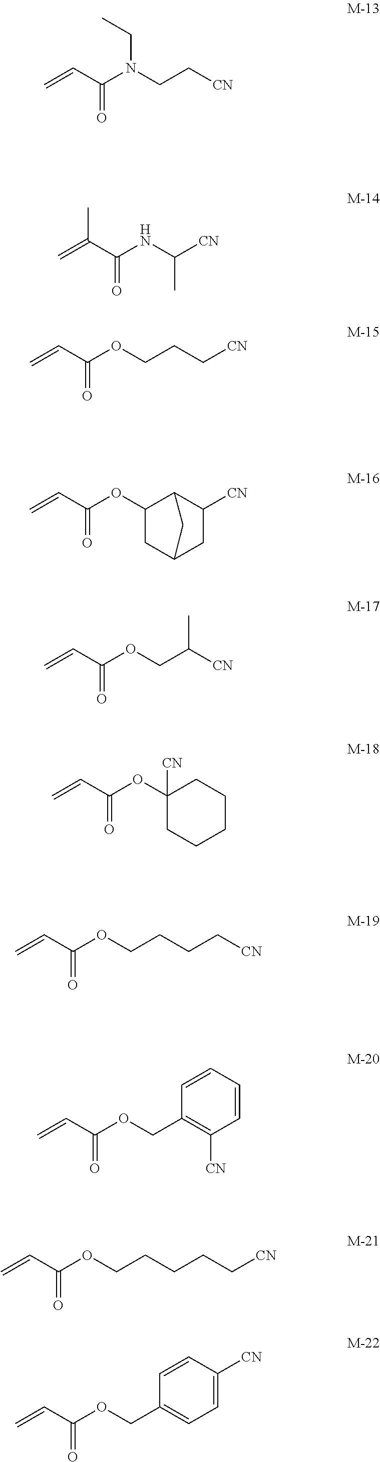

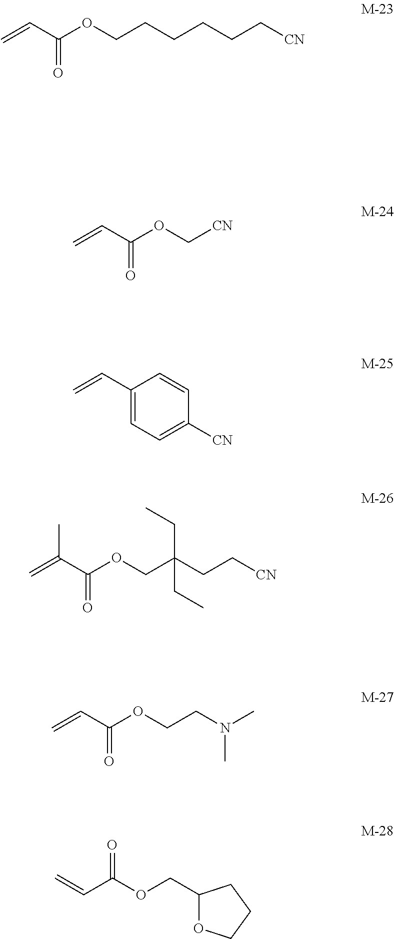

Two or more kinds of the first monomers may be used in combination.

(Second Monomer)

The second monomer has polyfunctionality.

When the ink composition includes the second monomer having polyfunctionality, the film strength of the image to be formed is improved.

Further, the second monomer is preferably a monomer which includes two or more ethylenically unsaturated bonds and has radical polymerizability.

Examples of the second monomer include a polyfunctional monomer having two or more groups each including an ethylenically unsaturated double bond.

Examples of such a polyfunctional monomer may include a polyfunctional monomer having two or more groups (each group including an ethylenically unsaturated double bond) selected from the group consisting of acrylate groups, methacrylate groups, acrylamido groups, methacrylamido groups, vinyloxy groups, and N-vinyl groups.

More specific examples of the second monomer include bis(4-acryloxy polyethoxy phenyl)propane, neopentyl glycol di(meth)acrylate, 1,6-hexanediol di(meth)acrylate, 1,9-nonanediol di(meth)acrylate, ethylene glycol di(meth)acrylate, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, tetrapropylene glycol di(meth)acrylate, polypropylene glycol di(meth)acrylate, pentaerythritol tri(meth)acrylate, pentaerythritol tetra(meth)acrylate, dipentaerythritol tetra(meth)acrylate, trimethylolpropane tri(meth)acrylate, tetramethylolmethane tetra(meth)acrylate, tetramethylolmethane tri(meth)acrylate, dimethylol tricyclodecane di(meth)acrylate, modified glycerin tri(meth)acrylate, modified bisphenol A di(meth)acrylate, PO adducted bisphenol A di(meth)acrylate, EO adducted bisphenol A di(meth)acrylate, dipentaerythritol hexa(meth)acrylate, and caprolactone modified dipentaerythritol hexa(meth)acrylate.

Further, a non-cyclic polyfunctional monomer that does not have a cyclic structure is also preferable as the second monomer. Above all, a polypropylene di(meth)acrylate-based or polyethylene glycol di(meth)acrylate-based polyfunctional monomer is preferable. Specific examples of the polyfunctional monomer may include ethylene glycol di(meth)acrylate, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, tetrapropylene glycol di(meth)acrylate, and polypropylene glycol di(meth)acrylate.

One kind of the second monomers may be used alone, or two or more kinds thereof may be used in combination.

Further, the content of the polymerizable groups contained in the second monomers is preferably from 0.5 mmol/g to 2.0 mmol/g (more preferably from 0.6 mmol/g to 1.6 mmol/g, and even more preferably from 0.8 mmol/g to 1.2 mmol/g) with respect to the total amount of the ink composition. When the content of the polymerizable groups contained in the second monomers is within the above range, the crosslink density in the formation of a cured film (a polymer film) using the monomer can be set in a more preferable range.

Here, the above-described content of the polymerizable groups can be calculated by multiplying the number of moles of the second monomers included in 1 g of the ink composition by the number of the polymerizable groups contained in the structure of the second monomer.

Namely, for example, in a case in which plural kinds of polyfunctional monomers are used in combination as the second monomer, the content of the polymerizable groups in the ink composition may be set in the above range by appropriately adjusting the proportion of the monomers used, considering the number of ethylenically unsaturated double bonds (also referred to as the number of functionality) included in each monomer.

(Third Monomer)

The ink composition according to the present invention may further include, as a third monomer, a monofunctional monomer other than the first monomer, that is, a monofunctional monomer that does not contain the above interactive group (at least one group selected from a cyano group, an alkyloxy group, an amino group, a pyridine residue, a pyrrolidone residue, an imidazole residue, an alkylsulfanyl group, or a cyclic ether residue). One kind of the third monomers may be used alone, or two or more kinds thereof may be used in combination.

Examples of the third monomer include acrylate compounds such as 2-phenylethyl acrylate, 2-hydroxyethyl acrylate, carbitol acrylate, cyclohexyl acrylate, benzyl acrylate, tridecyl acrylate, 2-phenoxyethyl acrylate, N-methylol acrylamide, diacetone acrylamide, epoxy acrylate, isobornyl acrylate, dicyclopentenyl acrylate, dicyclopentenyloxyethyl acrylate, dicyclopentanyl acrylate, 2-hydroxy-3-phenoxypropyl acrylate, 2-acryloyloxyethyl phthalate, 2-acryloyloxyethyl-2-hydroxyethyl phthalate, cyclic trimethylolpropane formal acrylate, 2-acryloyloxyethyl succinate, EO adducted nonylphenol acrylate, phenoxy-polyethylene glycol acrylate, 2-acryloyloxyethyl hexahydrophthalate, lactone-modified acrylate, stearyl acrylate, isoamyl acrylate, isomyristyl acrylate, isostearyl acrylate, or lactone-modified acrylate; methacrylate compounds such as methyl methacrylate, n-butyl methacrylate, allyl methacrylate, glycidyl methacrylate, benzyl methacrylate, or dimethylaminomethyl methacrylate; and allyl compounds such as allyl glycidyl ether.

Among these compounds, acrylate compounds are preferable. Above all, an acrylate having a cyclic hydrocarbon structure in a molecule thereof is preferable.

Further, monofunctional vinyl ether compounds are also preferable. Specific examples of the monofunctional vinyl ether compounds include methyl vinyl ether, ethyl vinyl ether, n-propyl vinyl ether, isopropyl vinyl ether, n-butyl vinyl ether, isobutyl vinyl ether, t-butyl vinyl ether, n-octadecyl vinyl ether, 2-ethylhexyl vinyl ether, n-nonyl vinyl ether, dodecyl vinyl ether, octadecyl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, 2-hydroxyethyl vinyl ether, 2-hydroxypropyl vinyl ether, 4-hydroxybutyl vinyl ether, 4-hydroxymethylcyclohexylmethyl vinyl ether, chloroethyl vinyl ether, chlorobutyl vinyl ether, phenylethyl vinyl ether, phenoxy-polyethylene glycol vinyl ether, cyclohexanedimethanol monovinyl ether, and isopropenyl ether-O-propylene carbonate.

(Monomer Content)

The ink composition in the present invention is characterized in that the total content of monomers included in the ink composition, namely, the sum obtained by adding the total content of the first monomers and the second monomers, and the content of the third monomers, which may be added as needed, is 85% by mass or greater. The total monomer content in the ink composition is more preferably from 87% by mass to 99% by mass, and even more preferably from 90% by mass to 95% by mass. When the total monomer content is within this range, the effects of the present invention may further be enhanced.

Further, the content of the first monomers (monomer having an interactive group) is preferably from 10% by mass to 80% by mass, more preferably from 15% by mass to 70% by mass, and even more preferably from 20% by mass to 65% by mass, based on the total amount of monomers included in the ink composition.

Further, the content of the second monomers (monomer having polyfunctionality) is preferably from 1% by mass to 20% by mass, more preferably from 3% by mass to 18% by mass, and even more preferably from 5% by mass to 15% by mass, based on the total amount of monomers included in the ink composition.

Moreover, in a case in which the third monomer (monofunctional monomer other than the first monomer) is used in combination, the content of the third monomers is preferably 50% by mass or less, more preferably from 5% by mass to 30% by mass, and even more preferably from 10% by mass to 20% by mass, based on the total amount of monomers included in the ink composition.

(Polymerization Initiator)

The ink composition in the present invention includes a polymerization initiator.

The polymerization initiator may be selected as appropriate from known polymerization initiators.

The polymerization initiator is preferably a compound that generates radicals, which are polymerization initiating species, by actinic energy rays. Examples of the actinic energy rays include γ-rays, β-rays, electron beams, ultraviolet rays, visible light rays, and infrared rays. For example, a so-called photopolymerization initiator is one example of a preferable polymerization initiator which can be used in the present invention.

As the polymerization initiator, a known compound may be used, and preferable examples of the polymerization initiator include (a) aromatic ketones, (b) acylphosphine oxide compounds, (c) aromatic onium salt compounds, (d) organic peroxides, (e) thio compounds, (f) hexaaryl biimidazole compounds, (g) ketoxime ester compounds, (h) borate compounds, (i) azinium compounds, (j) metallocene compounds, (k) active ester compounds, (l) compounds having a carbon-halogen bond, and (m) alkylamine compounds.

As the polymerization initiator, any of the compounds of (a) to (m) described above may be used alone, or two or more kinds thereof may be used in combination.

Preferable examples of (a) aromatic ketones, (b) acylphosphine oxide compounds, and (e) thio compounds include compounds having a benzophenone skeleton or a thioxanthone skeleton, which are described in “RADIATION CURING IN POLYMER SCIENCE AND TECHNOLOGY”, J. P. FOUASSIER and J. F. RABEK (1993), pages 77 to 117. More preferable examples may include α-thiobenzophenone compounds described in Japanese Patent Application Publication (JP-B) No. 47-6416, benzoin ether compounds described in JP-B No. 47-3981, α-substituted benzoin compounds described in JP-B No. 47-22326, benzoin derivatives described in JP-B No. 47-23664, aroyl phosphonate esters described in JP-A No. 57-30704, dialkoxybenzophenones described in JP-B No. 60-26483, benzoin ethers described in JP-B No. 60-26403 and JP-A No. 62-81345, α-aminobenzophenones described in JP-B No. 1-34242, U.S. Pat. No. 4,318,791, and European Patent No. 0284561A 1, p-di(dimethylaminobenzoyl)benzene described in JP-A No. 2-211452, thio-substituted aromatic ketones described in JP-A No. 61-194062, acylphosphine sulfides described in JP-B No. 2-9597, acylphosphines described in JP-B No. 2-9596, thioxanthones described in JP-B No. 63-61950, and coumalins described in JP-B No. 59-42864. Further, polymerization initiators described in JP-A Nos. 2008-105379 and 2009-114290 are also preferable.

Among these compounds, in the present invention, aromatic ketones and acylphosphine oxide compounds are preferably used as the polymerization initiator, and 1-cyclohexyl phenyl ketone, p-phenylbenzophenone (manufactured by Wako Pure Chemical Industries, Ltd.), 1-hydroxy-cyclohexyl phenyl ketone (IRGACURE 184, manufactured by BASF), bis(2,4,6-trimethylbenzoyl)-phenylphosphine oxide (IRGACURE 819, manufactured by BASF), bis(2,6-dimethoxybenzoyl)-2,4,4-trimethyl-pentylphenylphosphine oxide, 2,4,6-trimethylbenzoyl-diphenyl-phosphine oxide (DAROCUR TPO, manufactured by BASF, LUCIRIN TPO, manufactured by BASF), and the like are preferable.

One kind of polymerization initiators may be used alone, or two or more thereof may be used in combination.

The total content of the polymerization initiator(s) in the ink composition is preferably from 1% by mass to 15% by mass, more preferably from 1% by mass to 10% by mass, and even more preferably from 1% by mass to 5% by mass, with respect to the total amount of the ink composition.

(Additional Components)

The ink composition in the present invention may contain additional components as long as the effects of the invention are not impaired. Hereinafter, the additional components are described.

—Water—

The ink composition in the present invention may contain a trace amount of water as long as the effects of the invention are not impaired. However, the ink composition in the present invention is preferably a non-aqueous ink composition that does not substantially contain water. Specifically, the content of water is preferably 3% by mass or less, more preferably 2% by mass or less, and most preferably 1% by mass or less, with respect to the total amount of the ink composition. When the content of water is within this range, storage stability may be enhanced.

—Solvent—

The ink composition in the present invention may contain a trace amount of non-curable solvent for the purpose of adjusting the ink viscosity or the like.

Examples of the solvent include ketone solvents such as acetone, methyl ethyl ketone, diethyl ketone, or cyclohexanone; alcohol solvents such as methanol, ethanol, 2-propanol, 1-propanol, 1-butanol, or tert-butanol; chlorine-based solvents such as chloroform or methylene chloride; aromatic solvents such as benzene or toluene; ester solvents such as ethyl acetate, butyl acetate, isopropryl acetate, or propylene carbonate; ether solvents such as diethyl ether, tetrahydrofuran, or dioxane; and glycol ether solvents such as ethylene glycol monomethyl ether, ethylene glycol dimethyl ether, or propylene glycol monomethyl ether.

In a case in which the ink composition according to the present invention contains a solvent, the content of the solvent is preferably from 0.1% by mass to 10% by mass, more preferably from 0.1% by mass to 5% by mass, and even more preferably from 0.1% by mass to 3% by mass, with respect to the whole ink composition.

—Polymer Compound—

It is preferable that the ink composition in the present invention does not substantially contain a polymer compound having a molecular weight of equal to or greater than 1500. Specifically, the content of the polymer compound having a molecular weight of equal to or greater than 1500 is preferably 2.5% by mass or less, more preferably 2% by mass or less, and most preferably 1% by mass or less, with respect to the total amount of the ink composition. When the content is within this range, ejection recoverability after leaving (the ejection stability in a case in which ejection of the ink composition by using an inkjet recording apparatus is suspended, and the inkjet recording apparatus is left for a certain period, and then the ejection is resumed) may further be enhanced.

It is possible that the ink composition in the present invention contains a trace amount of polymer compound as long as the effects of the invention are not impaired. It is preferable that the polymer compound, which may be used, is oil-soluble, and examples of an oil-soluble polymer compound may include an acrylic polymer, a polyvinyl butyral resin, a polyurethane resin, a polyamide resin, a polyester resin, an epoxy resin, a phenol resin, a polycarbonate resin, a polyvinyl butyral resin, a polyvinyl formal resin, a shellac, a vinyl resin, an acrylic resin, a rubber resin, waxes, and other natural resins. Two or more kinds of these compounds may be used in combination. Above all, a vinyl copolymer which is obtained by copolymerization using an acrylic monomer is preferable. Further, copolymers including a structure unit of “carboxyl group-containing monomer”, “alkyl methacrylate”, or “alkyl acrylate” in a copolymer composition of the polymer compound are also preferably used.

—Surfactant—

The ink composition in the present invention may further contain a surfactant. The case in which a surfactant is incorporated is preferable, in view of inkjet ejection stability and leveling property at the time of landing of ink droplets.

Examples of the surfactant include a nonionic surfactant, an amphoteric surfactant, an anionic surfactant having an ammonium ion as the counter ion, and a cationic surfactant having an organic acid anion as the counter ion. Examples of the nonionic surfactant include polyethylene glycol derivatives and polypropylene glycol derivatives. Examples of the amophoteric surfactant include long chain alkyl betaines. Examples of the anionic surfactant having an ammonium ion as the counter ion include ammonium long chain alkyl sulfates, ammonium alkyl aryl sulfates, ammonium alkyl aryl sulfonates, ammonium alkyl phosphates, and ammonium salts of polycarboxylic acid-based polymers.

The content of the surfactant in the ink composition is not particularly limited, but is preferably from 0% by mass to 5% by mass, and more preferably from 0.01% by mass to 2% by mass, with respect to the total amount of the ink composition. When the content of the surfactant is within the above range, a preferable surface tension may be obtained without impairing other physical properties of the ink, which is thus preferable.

The ink composition in the present invention may contain, other than the above compounds, a polymerization inhibitor, a wax, a dye, a pigment, or the like, as necessary, as long as the effects of the invention are not impaired.

(Physical Properties of Ink Composition)

The physical properties of the ink composition in the present invention are not particularly limited as long as the physical properties are within the range capable of ejection using an inkjet head.

From the viewpoint of ejection stability, the viscosity of the ink composition at 25° C. is preferably 50 mPa·s or less, more preferably from 2 mPa·s to 20 mPa·s, and particularly preferably from 2 mPa·s to 15 mPa·s. Further, when ejection is performed using an apparatus, it is preferable that the temperature of the ink composition is maintained approximately at a constant temperature within a range of from 20° C. to 80° C., and it is more preferable that the viscosity of the ink composition at a temperature within this temperature range is 20 mPa·s or less. When the temperature of the apparatus is set at a higher temperature, the viscosity of the ink composition may be lowered, so that it becomes possible to discharge an ink composition having a higher viscosity.

However, from the viewpoints of more effectively suppressing denaturation or thermal polymerization reaction of the ink composition, evaporation of solvents, and clogging of nozzles due to these matters, which may be caused by high temperature, it is preferable that the temperature of the ink composition is 50° C. or lower.

The viscosity of the ink composition is a value measured by using a generally used E-type viscometer (for example, an E-type viscometer RE-80L, manufactured by TOKI SANGYO CO., LTD.).

Further, the surface tension (static surface tension) of the ink composition at 25° C. is preferably from 20 mN/m to 40 mN/m, and more preferably from 20 mN/m to 35 mN/m, from the viewpoints of improvement in wetting property with respect to a non-permeable substrate and ejection stability.

The surface tension described above is a value measured by using a generally used surface tensiometer (for example, a surface tensiometer, FACE SURFACE TENSIOMETER CBVB-A3, manufactured by Kyowa Interface Science Co., Ltd., or the like) in accordance with the Wilhelmy method at a liquid temperature of 25° C. and 60 RH %.

<Method for Manufacturing Metal Film Material>

The method for manufacturing a metal film material of the present invention includes a step (A) of applying the ink composition described above onto a substrate via an inkjet method, a cured film forming step (B) of forming a cured film by carrying out at least one of light exposure or heating of the ink composition that has been applied, a catalyst application step (C) of applying a plating catalyst or a precursor thereof to the cured film, and a plating processing step (D) of performing plating with respect to the plating catalyst or precursor thereof that has been applied. In the followings, details of each step are described.

(Ink Application Step (A))

The ink application step (A) is a step of applying the ink composition described above by discharging onto a substrate via an inkjet method.

The inkjet method is a method of discharging a picoliter scale liquid toward a substrate from a liquid discharge port in accordance with a signal for recording (digital data). According to the inkjet method, it is possible to apply an ink pattern-wise, to form a fine pattern.

The inkjet method in this step is not particularly limited, and may be of any conventionally known methods, for example, a method of successively jetting a charged ink composition while controlling through an electric field, a method of intermittently jetting an ink composition using a piezoelectric element, a method of heating an ink composition and intermittently jetting the ink composition utilizing the bubbles thereof, or the like. Namely, image drawing by the inkjet method may be performed by any conventionally known system, such as a piezo inkjet system or a thermal inkjet system. Further, as the inkjet recording apparatus used for the inkjet method, not only a generally used inkjet image drawing apparatus, but also an image drawing apparatus equipped with a heater or the like can be used.

As the inkjet head to be used for the above inkjet method, inkjet heads (ejection heads) of various systems such as a continuous type or on-demand type piezo system, a thermal system, a solid system, or an electrostatic attraction system can be used. Further, the arrangement of the ejection portions (nozzles) in the inkjet head is not limited to a single row arrangement, and may be an arrangement of plural rows or may be a staggered arrangement.

In this step, the ink composition according to the present invention is discharged to the place where a metal film should be formed on the substrate, by the inkjet method. In this process, the ink composition may be applied to the entire surface of the substrate, or may be applied in a desired pattern form. Namely, when the ink composition is applied onto the entire surface of the substrate, a metal film material having a metal film on its entire surface can be obtained, and when the ink composition is discharged pattern-wise to be applied selectively, a metal film material (a metal pattern material) having a metal film in a desired pattern form can be obtained.

After discharging the ink composition onto the substrate, a drying treatment may be performed, as necessary. Such a drying treatment may be performed by a treatment using, for example, a hot plate, an electric furnace, or the like, or also by lamp annealing.

(Cured Film Forming Step (B))

The cured film forming step (B) is a step of forming a cured film by carrying out at least one of light exposure or heating of the ink composition that has been applied, to polymerize and cure the monomer components in the ink composition. At least one of light exposure or heating may be carried out, as long as the ink composition can be cured, but from the viewpoint of ease of formation of a pattern image, it is preferable to carry out at least light exposure.

Regarding the light exposure, irradiation with actinic energy rays (ultraviolet rays, γ-rays, β-rays, electron beams, visible light rays, infrared rays, or the like) may be used. As the light source which may be used for the light exposure (for example, irradiation with actinic energy rays), for example, an ultraviolet ray irradiation lamp, a halogen lamp, a high pressure mercury lamp, a laser, an LED, an electron beam irradiation equipment, or the like can be employed.

The wavelength of the actinic energy ray is preferably, for example, from 200 nm to 600 nm, more preferably from 300 nm to 450 nm, and even more preferably from 350 nm to 420 nm.

The power of the actinic energy ray is preferably 5000 mJ/cm² or less in terms of the integrated exposure amount, more preferably from 10 mJ/cm² to 4000 mJ/cm², and even more preferably from 20 mJ/cm² to 3000 mJ/cm².

In a case in which heating is employed in this step, an air blowing type dryer, an oven, an infrared dryer, a heating drum, or the like may be used as the heating means. The conditions for heating are not particularly limited, but generally, heating is performed at a temperature of from 100° C. to 300° C. for 5 minutes to 120 minutes.

When application of energy is carried out by means of light exposure or heating as described above, polymerization reaction of the monomer components occurs and a cured film is formed at the region to which the ink composition has been applied.

The thickness of the cured film to be formed is not particularly limited, but from the viewpoint of realizing more excellent adhesion to the metal film described below, the thickness of the cured film is preferably from 0.1 μm to 10 μm, and more preferably from 0.3 μm to 5 μm. The thickness of the cured film may be adjusted by appropriately setting the amount of the ink composition which is applied in the ink discharging step (A).

When the cured film forming step (B) is carried out in an environment having an oxygen concentration of 10% or less, more preferably at an oxygen concentration of 8% or less, and even more preferably at an oxygen concentration of 5% or less, the etching resistance can be further improved.

In the cured film forming step (B), for controlling the oxygen concentration, a nitrogen purging-type UV irradiation equipment (for example, CSN2-40, manufactured by GS Yuasa International Ltd.) can be used. Further, the oxygen concentration can be measured by using an oxygen analyzer, for example, COSMOTECTOR XP-3180 (manufactured by New Cosmos Electric Co., Ltd.) or the like.

—Substrate—

The substrate used in this step may have a shape retaining property, and it is preferable that the substrate is a dimensionally stable plate-shaped substance.

Examples of the substrate, which may be used, include paper, paper laminated with a plastic (for example, polyethylene, polypropylene, polystyrene, or the like), a plate of a metal (for example, aluminum, zinc, copper, or the like), a film of a plastic (for example, cellulose diacetate, cellulose triacetate, cellulose propionate, cellulose butyrate, cellulose acetate, cellulose nitrate, polyethylene terephthalate, polyethylene, polystyrene, polypropylene, polycarbonate, polyvinyl acetal, a polyimide resin, an epoxy resin, a bismaleimide resin, polyphenylene oxide, a liquid crystal polymer, polytetrafluoroethylene, or the like), and paper or a plastic film onto which a metal as described above is laminated or deposited.

An epoxy resin or a polyimide resin is preferable, as the substrate used in the present invention.

The metal film material obtained by the method for manufacturing a metal film material of the present invention may be applied to semiconductor packages, various electrical wiring boards, or the like. In the case of using the metal film material for such applications, it is preferable to use, as the substrate, a substrate formed from an insulating resin or a substrate having a layer formed from an insulating resin on its base material.

Here, the term “insulating resin” used in the present invention means a resin having an insulating property that is tolerable for use in known insulating films or insulating layers, and a resin that is not completely insulating is also involved in the “insulating resin” in the present invention, as long as the resin has an insulating property according to purposes.

As the insulating resin, for example, resins described in paragraphs [0024] to [0025] of JP-A No. 2008-108791 can be used.

(Catalyst Application Step (C))

The catalyst application step is a step of applying a plating catalyst or a precursor thereof to the cured film that has been formed in the cured film forming step (B). In this step, the interactive group (at least one group selected from a cyano group, an alkyloxy group, an amino group, a pyridine residue, a pyrrolidone residue, an imidazole residue, an alkylsulfanyl group, or a cyclic ether residue), that the first polymer included in the ink composition possesses, adsorbs the applied plating catalyst or precursor thereof, corresponding to the function of the interactive group.

Here, examples of the plating catalyst or precursor thereof include those that function as a catalyst or electrode for plating in the plating processing step (D) described below. Accordingly, the type of the plating catalyst or precursor thereof is appropriately determined depending on the type of plating performed in the plating processing step (D).

Further, the plating catalyst or precursor thereof which is used in this step is preferably an electroless plating catalyst or an electroless plating catalyst precursor.

—Electroless Plating Catalyst—

As the electroless plating catalyst, any compound may be used as long as the compound serves as an active nucleus at the time of electroless plating.

Specific examples of the electroless plating catalyst include metals having catalytic activity for an autocatalytic reduction reaction (for example, those known as metals capable of being deposited electrolessly and having an ionization tendency lower than that of Ni) and the like; and more specific examples include Pd, Ag, Cu, Ni, Al, Fe, and Co. Above all, those having an ability of forming multidentate coordination are preferable, and especially, from the viewpoints of the number of types of functional groups capable of forming coordination and the superiority in the catalytic activity, Pd is particularly preferable.

The electroless plating catalyst may be used in the form of a metal colloid. A metal colloid can generally be prepared by reducing metal ions in a solution where a charged surfactant or a charged protective agent is present. The charge of the metal colloid can be adjusted by the surfactant or protective agent used herein.

—Electroless Plating Catalyst Precursor—

The electroless plating catalyst precursor can be used without any particular limitation, as long as it can become an electroless plating catalyst through a chemical reaction. Mainly, a metal ion of a metal described above as the electroless plating catalyst (or a compound containing the metal ion (for example, a metal salt or a metal complex)) is used. The metal ion that serves as an electroless plating catalyst precursor becomes a zero-valent metal that serves as an electroless plating catalyst through a reduction reaction. During a period after the application of a metal ion that serves as an electroless plating catalyst precursor but before dipping into an electroless plating bath, the metal ion may be converted into a zero-valent metal to obtain an electroless plating catalyst by a separate reduction reaction; or the electroless plating catalyst precursor may be dipped into an electroless plating bath as it is and converted into a metal (electroless plating catalyst) by a reducing agent contained in the electroless plating bath.

Practically, the metal ion that serves as an electroless plating catalyst precursor is applied onto the above-described cured film by using a metal salt. The metal salt is not particularly limited, as long as the metal salt dissolves in an appropriate solution, to dissociate into a metal ion and a base (anion), and examples thereof include M(NO₃)ₙ, MClₙ, M_{2/n}(SO₄), and M_{3/n}(PO₄)Pd(OAc)ₙ (wherein M represents a metal atom having a valency of n).

As the metal ion, those obtained through dissociation of the above metal salts can be appropriately used.

Specific examples of the metal ion include an Ag ion, a Cu ion, an Al ion, an Ni ion, a Co ion, an Fe ion, and a Pd ion, and above all, metal ions having an ability of forming multidentate coordination are preferable, and particularly, a Pd ion is preferable in view of the number of types of functional groups capable of forming coordination and the catalytic activity.

One preferable example of the electroless plating catalyst or precursor thereof used in the present invention is a palladium compound. The palladium compound acts as a plating catalyst (palladium) or a precursor thereof (palladium ion), which serves as an active nucleus at the time of plating processing and plays a role in deposition of a metal.

The palladium compound is not particularly limited as long as the compound contains palladium and acts as a nucleus at the time of plating processing. Examples of the palladium compound include a palladium salt, a palladium (0) complex, and a palladium colloid.

Example of a method of applying a metal that serves as an electroless plating catalyst or a metal ion that serves as an electroless plating catalyst precursor onto the cured film include a method of preparing a dispersion liquid by dispersing a metal in an appropriate dispersion medium, or a solution containing dissociated metal ions by dissolving a metal salt in an appropriate solvent, and then coating the dispersion liquid or the solution onto the cured film, and a method of dipping a substrate having the cured film formed thereon into the dispersion liquid or the solution.

When the electroless plating catalyst or precursor thereof is brought into contact with the cured film as described above, the electroless plating catalyst or precursor thereof can be adsorbed to the interactive group (at least one group selected from a cyano group, an alkyloxy group, an amino group, a pyridine residue, a pyrrolidone residue, an imidazole residue, an alkylsulfanyl group, or a cyclic ether residue), that the first polymer included in the ink composition possesses, by utilizing an interaction caused by an intermolecular force such as van der Waal's force, an interaction caused by a coordinate bond due to a lone electron pair, or the like.

From the viewpoint of achieving the above adsorption to a sufficient level, the concentration of metal in the dispersion liquid, solution, or composition or the concentration of metal ions in the solution is preferably in a range of from 0.001% by mass to 50% by mass, and more preferably in a range of from 0.005% by mass to 30% by mass. Further, the time for contacting is preferably from about 30 seconds to about 24 hours, and more preferably from about 1 minute to about 1 hour.

Further, a liquid that contains a plating catalyst or a precursor thereof (plating catalyst liquid) may contain an organic solvent. When the organic solvent is contained, permeability of the plating catalyst or precursor thereof into the cured film may be improved, and the plating catalyst or precursor thereof can be adsorbed efficiently to the interactive group (at least one group selected from a cyano group, an alkyloxy group, an amino group, a pyridine residue, a pyrrolidone residue, an imidazole residue, an alkylsulfanyl group, or a cyclic ether residue).

The organic solvent which is used for preparing the plating catalyst liquid is not particularly limited as long as the organic solvent can permeate into a polymer layer, but a water-soluble organic solvent is preferable, since water is generally used as the main solvent (dispersion medium) of the plating catalyst liquid.

The water-soluble organic solvent is not particularly limited, as long as the organic solvent dissolves in water in an amount of 1% by mass or more. Examples of the water-soluble organic solvent include water-soluble organic solvents such as ketone solvents, ester solvents, alcohol solvents, ether solvents, amine-based solvents, thiol-based solvents, or halogen-containing solvents.

—Other Catalyst—

In the present invention, a zero-valent metal can be used, as a catalyst used for directly performing electroplating without performing electroless plating with respect to the cured film in the plating processing step (D) described below. Examples of the zero-valent metal include Pd, Ag, Cu, Ni, Al, Fe, and Co; and above all, those having an ability of forming multidentate coordination are preferable, and particularly, Pd, Ag, and Cu are preferable from the viewpoints of adsorptivity with respect to the interactive group (most preferably, a cyano group) and the superiority in the catalytic activity.

By going through the catalyst application step (C) as explained above, an interaction between the interactive group (at least one group selected from a cyano group, an alkyloxy group, an amino group, a pyridine residue, a pyrrolidone residue, an imidazole residue, an alkylsulfanyl group, or a cyclic ether residue), that the first polymer included in the ink composition possesses, and the plating catalyst or precursor thereof can be formed. The cured film, to which the plating catalyst has been applied, is used as a plating accepting layer to be subjected to plating processing.

(Plating Processing Step (D))

The plating processing step (D) is a step of forming a plated film (a metal film) by performing plating processing with respect to the cured film to which an electroless plating catalyst or a precursor thereof has been applied in the above catalyst application step (C). The plated film thus formed has excellent conductivity and excellent adhesion to the cured film.

Examples of the form of plating capable of being applied to this step include electroless plating and electroplating. The form of plating may be selected as appropriate according to the function of the plating catalyst or precursor thereof which has formed an interaction with the cured film in the above catalyst application step (C).

Above all, in the present invention, it is preferable to perform electroless plating, from the viewpoint of improvement in the adhesion. Further, in order to obtain a plated layer having a desired film thickness, it is more preferable to further perform electroplating after the electroless plating. Hereinafter, the plating processing which is preferably performed in this step is explained.

—Electroless Plating—

Electroless plating refers to plating in a form in which a metal is deposited by means of a chemical reaction using a solution obtained by dissolving ions of the intended metal to be deposited as plating.

The electroless plating in this step is performed by, for example, washing the substrate, to which an electroless plating catalyst has been applied, with water to remove extra electroless plating catalyst (metal or the like), and then dipping the resulting substrate into an electroless plating bath. As the electroless plating bath used herein, a generally known electroless plating bath may be used.

Further, in a case in which a substrate to which an electroless plating catalyst precursor has been applied is dipped in an electroless plating bath, the substrate being in a state in which the electroless plating catalyst precursor is adsorbed or impregnated in the cured film, for example, the substrate is washed with water to remove excess precursor (metal salt or the like) and then the resulting substrate is dipped into the electroless plating bath. In this case, reduction of the plating catalyst precursor is carried out and subsequently, electroless plating is carried out in the electroless plating bath. Also in this case, as the electroless plating bath used herein, a generally known electroless plating bath may be used.

As to the reduction of the electroless plating catalyst precursor, other than the embodiment of using an electroless plating liquid as described above, it is possible to carry out the reduction of the electroless plating catalyst precursor, as a separate step prior to the electroless plating, by preparing a catalyst activating liquid (reducing liquid). The catalyst activating liquid is a liquid which is prepared by dissolving a reducing agent capable of reducing the electroless plating catalyst precursor (mainly, a metal ion) into a zero-valent metal. The concentration of the reducing agent in the catalyst activating liquid is preferably from 0.1% by mass to 50% by mass, and more preferably from 1% by mass to 30% by mass, with respect to the total amount of the liquid. Examples of the reducing agent, which can be used, include boron-based reducing agents such as sodium borohydride or dimethylamine borane, and reducing agents such as formaldehyde or hypophosphorous acid.

Generally, the electroless plating bath includes as main components, in addition to a solvent, 1. a metal ion for plating, 2. a reducing agent, and 3. an additive (stabilizer) that enhances the stability of the metal ions. This plating bath may further contain a known additive, in addition to the above components.

The organic solvent used in the plating bath is preferably a solvent that is soluble in water, and from this point of view, ketones such as acetone, or alcohols such as methanol, ethanol, or isopropanol are preferably used.

Regarding the type of the metal used in the electroless plating bath, copper, tin, lead, nickel, gold, palladium, and rhodium are known. From the viewpoint of conductivity, the metal used in the electroless plating bath is preferably copper or gold.

Further, there are preferable reducing agents and additives according to the type of the metal.

For example, an electroless plating bath used for electroless plating of copper preferably includes CuSO₄ as the salt of copper, HCOH as the reducing agent, and a chelating agent that serves as a stabilizer of the copper ion, such as ethylenediaminetetraacetic acid (EDTA) or Rochelle salt, trialkanolamine, or the like, as the additive.

Further, an electroless plating bath used for electroless plating of CoNiP preferably includes cobalt sulfate and nickel sulfate as the metal salts thereof, sodium hypophosphite as the reducing agent, and sodium malonate, sodium malate, or sodium succinate as the complexing agent.

Moreover, an electroless plating bath used for electroless plating of palladium preferably includes (Pd(NH₃)₄)Cl₂ as the metal ion, NH₃ or H₂NNH₂ as the reducing agent, and EDTA as the stabilizer.

These plating baths may further include components other than the above components.

The film thickness of the plated film (metal film) formed by the electroless plating described above can be controlled by adjusting the concentration of the metal ion in the plating bath, the time for dipping in the plating bath, the temperature of the plating bath, or the like. From the viewpoints of conductivity and adhesion, the film thickness of the plated film (metal film) is preferably from 0.2 μm to 4.0 μm, more preferably from 0.2 μm to 3.0 μm, and particularly preferably from 0.2 μm to 2.0 μm.

Further, the time for dipping into the plating bath is preferably from about 1 minute to about 6 hours, and more preferably from about 1 minute to about 3 hours.

—Electroplating—

In this step, in a case in which the plating catalyst or precursor thereof that has been applied in the above catalyst application step (C) has a function as an electrode, electroplating (hereinafter, may also be referred to as “electrolytic plating”) can be performed with respect to the cured film to which the catalyst or precursor thereof has been applied.

Further, after performing the electroless plating described above, electroplating may further be performed using the formed plated film as the electrode. Hereby, a new metal film having an arbitrary thickness can be easily formed by using the electroless plated film that exhibits excellent adhesion to the substrate, as a base. Thus, by performing electroplating after the electroless plating, a metal film having a thickness according to the purpose can be formed, which is preferable to apply the metal film according to the present invention to various applications.

As to the method of performing electroplating in the present invention, a conventionally known method can be used. Examples of a metal which may be used in the electroplating of this step include copper, chrome, lead, nickel, gold, silver, tin, and zinc, and among them, from the viewpoint of conductivity, copper, gold, and silver are preferable, and copper is more preferable.

Further, regarding the film thickness of the metal film obtained by the electroplating may vary according to the intended use, and can be controlled by adjusting the concentration of the metal contained in the plating bath, the current density, or the like. Note that, in the case of using the metal film for general electric wirings or the like, the film thickness is preferably from 1.0 μm to 30 μm, from the viewpoint of conductivity.

<Metal Film Material>

A metal film material of the present invention can be obtained by going through the respective steps of the method for manufacturing a metal film material described above.

This metal film material can be applied to various applications, for example, in electric wiring materials, electromagnetic wave protecting films, coating films, double layer CCL (copper clad laminate) materials, ornament materials, or the like.

Here, in the ink application step (A) described above, when the ink composition is discharged in a desired pattern form and is selectively applied, by going through the above plating processing step (D), a metal film material (a metal pattern material) having a patterned metal film can instantly be obtained. However, in the present invention, first, the ink composition may be applied onto the entire surface of a substrate to form a metal film material having a metal film on the entire surface of the substrate, and separately, an etching step may be provided to form a metal film in a desired pattern form.

This etching step is described below in detail.

(Etching Step)

This step is a step of etching the metal film (plated film) that has been formed in the above plating processing step (D) into a pattern form. Namely, in this step, etching is performed to remove the unnecessary portions of the metal film that has been formed on the substrate surface, and a desired metal pattern can be formed.

Any available technique may be used for the formation of this metal pattern and specifically, a subtractive method or a semi-additive method, which are generally known, is used.

The subtractive method is a method of forming a metal pattern by providing a dry film resist layer on a metal film that has been formed, performing pattern exposure and development to form a dry film resist pattern which has the same pattern as the metal pattern intended to be formed, and removing the metal film using the formed dry film resist pattern as a mask and an etching liquid.

Any material may be used as the dry film resist, and a negative type, positive type, liquid, or film-like material can be used. Further, for the etching method, any of methods which are used in the production of printed wiring boards may be used, specifically, wet etching, dry etching, or the like may be used, and the etching method may be arbitrary selected. From the viewpoint of workability of operation, wet etching makes use of convenient instruments and the like, which is thus preferable. As the etching liquid used in the wet etching, for example, an aqueous solution of cupric chloride, ferric chloride, or the like can be used.

The semi-additive method is a method of forming a metal pattern by providing a dry film resist layer on a metal film that has been formed, performing pattern exposure and development to form a dry film resist pattern which has the same pattern as that of a region other than the region of the metal pattern intended to be formed, performing electroplating while using the formed dry film resist pattern as a mask, and thereafter, after removing the dry film resist pattern, carrying out quick etching, and removing a portion of the metal film which is covered with the dry film resist pattern in a pattern form. The same materials as those used in the subtractive method may be used for the dry film resist, the etching liquid, and the like. Further, the technique described above may be used for the electroplating technique.

By going through the above-described etching step, a metal film material having a desired metal pattern can be formed.

In a case in which the metal film material of the present invention is used to form a multilayer wiring board, an insulating resin layer (interlayer insulating film) may further be disposed on the surface of the metal film material, and a wiring (metal pattern) may further be formed on its surface, or a solder resist may be formed on the surface of the metal film material.

Examples of the insulating resin layer (interlayer insulating film) include an epoxy resin, an aramid resin, a crystalline polyolefin resin, a non-crystalline polyolefin resin, a fluorine-containing resin, a polyimide resin, a polyether sulfone resin, a polyphenylene sulfide resin, a polyether ether ketone resin, and a liquid crystal resin.

Among the above resins, from the viewpoints of adhesion to the polymer layer described above, dimensional stability, heat resistance, electric insulating property, and the like, it is preferable that the insulating resin layer includes an epoxy resin, a polyimide resin, or a liquid crystal resin.

Further, as the solder resist, known materials can be used and, for example, materials described in detail in JP-A Nos. 10-204150 and 2003-222993 and the like can be used. As the solder resist, a commercially available product can be used, and specific examples thereof include PFR800 (trade name) and PSR4000 (trade name), all manufactured by TAIYO INK MFG. CO., LTD., and SR7200G (trade name) manufactured by Hitachi Chemical Co., Ltd.

### EXAMPLES

Hereinafter, the present invention is described in more detail with reference to Examples, but the scope of the present invention is not limited to these Examples. The “%” and “parts” are based on mass, unless otherwise specified.

Regarding the measurement of weight average molecular weight described below, the polymer was dissolved in NMP, and the weight average molecular weight of the polymer was measured by using a high-speed GPC (trade name: HLC-8220GPC) manufactured by Tosoh Corporation. The molecular weight was calculated in terms of polystyrene. Further, the structure of the polymer was defined by using ¹H-NMR (manufactured by Bruker Instruments; 400 MHz).

### Synthesis Example 1

### Synthesis of Monomer M-15 (Cyanopropyl Acrylate; First Monomer)

To a 200 mL three-necked flask, 33 g of dimethyl sulfoxide, 33 g of water, 14.8 g of potassium hydrogencarbonate, 10 g of 4-bromobutyronitrile, and 10 mg of 4-hydroxy TEMPO (4-hydroxy-2,2,6,6-tetramethylpiperidine 1-oxyl free radical) were added. Thereafter, 9.8 g of acrylic acid were added thereto dropwise. Then, the contents of the flask were heated to 80° C., and stirred at 80° C. for 4 hours. The resulting reaction liquid was cooled to room temperature. After cooling, the reaction liquid was washed with water, and was purified by column chromatography, to obtain 9 g of 3-cyanopropyl acrylate.

The first monomers besides M-15, which were used in Examples, are as follows. (Monomer M-3 (first monomer))

2-(2-ethoxyethoxy)ethyl acrylate (manufactured by Sigma-Aldrich Corporation) (Monomer M-6 (first monomer))

cyanoethyl acrylate (manufactured by Tokyo Chemical Industry Co., Ltd.) (Monomer M-9 (first monomer))

1-vinyl-2-pyrrolidone (manufactured by Sigma-Aldrich Corporation) (Monomer M-10 (first monomer))

1-vinylimidazole (manufactured by Sigma-Aldrich Corporation)

<Production of Ink Composition>

Using the first monomers described above, according to the composition ratio shown in Table 1 below, ink compositions (Inks 1 to 13 and Comparative Inks 1 to 3) were prepared. Note that, the “%” in Table 1 represents “% by mass”.

Details of each material used in the preparation of ink are shown below.

(Monomer Having Polyfunctionality (Second Monomer))

Dipropylene glycol diacrylate (bifunctional) (SR508, manufactured by Sartomer Company Inc.)

Diethylene glycol diacrylate (bifunctional) (SR230, manufactured by Sartomer Company Inc.)

Pentaerythritol tetraacrylate (tetrafunctional) (V#400, manufactured by Osaka Organic Chemical Industry Ltd.)

(Other Monofunctional Monomer (Third Monomer))

Phenoxyethyl acrylate (SR339, manufactured by Sartomer Company Inc.)

(Polymerization Initiator)

1-Hydroxy-cyclohexyl phenyl ketone (IRGACURE 184, manufactured by BASF)

2,4,6-trimethylbenzoyl-diphenyl-phosphine oxide (TPO) (LUCIRIN TPO, manufactured by BASF)

(Surfactant)

Silicone-based surfactant (BYK-307, manufactured by BYK Chemie)

Silicone-based surfactant (BYK-323, manufactured by BYK Chemie)

Fluorosurfactant (F-781F, DIC Corporation)

<Ejection Recoverability After Leaving (Ejection Stability in a Case in which Ejection of an Ink Composition by Using an Inkjet Recording Apparatus is Suspended, and the Inkjet Recording Apparatus is Left for a Certain Period, and then the Ejection is Resumed)>

Using each of the ink compositions (Inks 1 to 13 and Comparative Inks 1 to 3) prepared as described above, the ejection recoverability after leaving was evaluated according to the following method.

Ejection of each ink was conducted by using an inkjet printer DMP-2831 (trade name, manufactured by FUJIFILM Dimatix, Inc.) and using 10 nozzles at a frequency of 4 kHz, and the dischargeability was confirmed, and then the ejection was suspended, and the inkjet printer was left for 60 minutes. Thereafter, pressure purge and head cleaning were conducted, and ejection was carried out again under the same conditions as described above, whereby the ejection recoverability after leaving was evaluated.

In this evaluation of “ejection recoverability after leaving”, the case in which ejection is performed in all the 10 nozzles without any problems is evaluated as “A”, the case in which non-ejection or flight deviation occurs in 1 or 2 nozzles is evaluated as “B”, the case in which non-ejection or flight deviation occurs in 3 to 5 nozzles is evaluated as “C”, and the case in which non-ejection or flight deviation occurs in 6 or more nozzles, or the case in which the initiation of ejection itself is impossible in all the nozzles is evaluated as “D”.

Results are shown in Table 1.

<Production of Metal Film Material>

(Preparation of Substrate)

A 9% by mass cyclohexane solution of ABS resin (manufactured by Sigma-Aldrich Corporation) was coated onto a glass epoxy base material by a spin coating method (conditions: at 250 rpm for 5 seconds and thereafter, at 750 rpm for 20 seconds), and dried, to form an adhesion auxiliary layer having a thickness of 3 μm, thereby obtaining a substrate used in Examples.

(Preparation of Cured Film)

—Line Drawing—

Using each of the ink compositions (Inks 1 to 13 and Comparative Inks 1 to 3) prepared as described above, cured films were prepared, respectively, according to the following method.

The ink composition was discharged onto the adhesion auxiliary layer of the substrate by using an inkjet printer DMP-2831, manufactured by FUJIFILM Dimatix, Inc., thereby drawing a straight line (line) pattern having a line width of 100 μm and a length of 5 cm.

Next, the straight line (line) pattern that had been drawn as described above was exposed to light, to form a line-shaped cured film. The above light exposure was conducted using a metal halide light source exposure apparatus: U-0272 (trade name, manufactured by GS Yuasa International Ltd.) under the condition such that the integrated light intensity of the entire emission wavelength was 2000 mJ/cm².

Further, the above exposure was conducted in an environment having an oxygen concentration of 21%.

—Application of Plating Catalyst—

In a mixed solvent of water:acetone=80:20 (mass ratio), 0.5% by mass of palladium nitrate with respect to the total amount of the mixed solvent was dissolved, and the undissolved matter was removed by filtration through a filter paper.

Into the solution (filtrate) thus obtained, the above-described substrate (hereinafter, may also be referred to as the “object to be plated”) having a line-shaped cured film was dipped for 15 minutes.

After performing dipping as described above, the object to be plated was washed by dipping into a mixed solvent of water:acetone=80:20 (mass ratio) for 15 minutes.

—Electroless Plating—

To an electroless plating bath having the composition described below, sodium hydride and sulfuric acid were added, to adjust the pH to 13.0. The object to be plated, which had been subjected to washing as described above, was dipped into the electroless plating bath (temperature: 30° C.), that had been subjected to the pH adjustment, for 60 minutes, whereby electroless plating was performed. In this way, a line-shaped metal film (electroless copper-plated film) having a film thickness of 3 μm was formed on the cured film of the object to be plated.

Here, the composition of the electroless plating bath is as follows. In the composition below, PGT-A liquid, PGT-B liquid, and PGT-C liquid are each THRU-CUP PGT (A liquid, B liquid, and C liquid) which is a plating bath manufactured by C. Uyemura & Co., Ltd.

(Composition of Electroless Plating Bath)

Distilled water: 79.2% by mass

PGT-A liquid: 9.0% by mass

PGT-B liquid: 6.0% by mass

PGT-C liquid: 3.5% by mass

Formaldehyde (manufactured by Wako Pure Chemical Industries, Ltd.): 2.3% by mass

The metal film thus obtained was visually observed, and it was found that a uniform film was formed and a good line-shaped metal film was obtained.

—Solid Drawing—

Under the same conditions as those in the line drawing described above, using an inkjet printer DMP-2831, manufactured by FUJIFILM Dimatix, Inc., the ink composition was discharged onto the adhesion auxiliary layer of the substrate, thereby drawing a solid pattern in a square shape having a size of 50 mm×50 mm. The solid pattern thus obtained was exposed to light, to obtain a solid cured film.

The solid cured film thus obtained was subjected to plating catalyst application and electroless plating, under the same conditions as those in the above line drawing, to form a solid electroless copper-plated film on the solid cured film.

Further, after the electroless plating processing, the following electrolytic plating processing was performed, to obtain a solid metal film (a copper-plated film having a film thickness of from 8 μm to 10 μm).

—Electrolytic Plating—

Electrolytic plating (electroplating) was performed for 15 minutes under the condition of 3 A/dm², using the electroless copper-plated film, that had been formed by the above electroless plating processing, as a power supply layer, and using an electrolytic copper plating bath having the following composition.

(Composition of Electrolytic Plating Bath)

Copper sulfate (manufactured by Wako Pure Chemical Industries, Ltd.) 38 g

Sulfuric acid (manufactured by Wako Pure Chemical Industries, Ltd.) 95 g

Hydrochloric acid (manufactured by Wako Pure Chemical Industries, Ltd.) 1 mL

COPPER GLEAM PCM (manufactured by Meltex, Inc.) 3 mL

Water 500 g

Using the substrate (hereinafter, referred to as “metal film material”) having a solid metal film (copper-plated film) formed thereon by the above electrolytic plating, a patterned metal film was formed in a manner as described below (by a so-called subtractive method), and the etching resistance of this metal film material was evaluated.

—Formation of Patterned Metal Film—

A dry film resist (trade name: PHOTEC RY3315, manufactured by Hitachi Chemical Co., Ltd.) was laminated on the surface of the metal film (copper-plated film) that had been formed by the above electrolytic plating.

The dry film resist thus laminated was irradiated (exposed) with an ultraviolet ray under the condition of an ultraviolet ray intensity of 120 mJ/cm², through a photo mask on which a comb-shaped wiring pattern having a line/space=100 μm/100 μm was drawn.

After the ultraviolet ray irradiation (exposure), the dry film resist was developed by using a 1% aqueous solution of sodium carbonate, whereby an etching resist having a comb-shaped wiring pattern was formed on the surface of the copper-plated film.

Subsequently, the copper-plated film at the region which was not covered with the etching resist was removed (etched) by an etching liquid including FeCl₃/HCl.

Thereafter, the etching resist was peeled and removed using an alkali removing liquid formed from 3% NaOH solution.

In this way, a comb-shaped wiring (patterned metal film) having a line/space=100 μm/100 μm was formed.

—Evaluation of Etching Resistance—

The etching resistance of the metal film material was evaluated by verifying the presence of defects and conductivity of the combed-shaped wiring obtained as described above.

In a case in which the etching resistance of the metal film material is low and the accuracy of the comb-shaped wiring (formation pattern) is low, defects or wire disconnection occurs on the comb-shaped wiring (formation pattern) and, as a result, the conductivity of electricity is also lowered. Thus, by observing the comb-shaped wiring (formation pattern) and by measuring the conductivity of the comb-shaped wiring (formation pattern), the etching resistance of the metal film material can be evaluated.

The shape of the comb-shaped wiring (formation pattern) was observed at 20,000× magnification using a scanning electron microscope, and was evaluated. In this process, with respect to 100 μm, which is the ideal line width of the formation pattern to be obtained, the case in which a line having a line width reduced to 50 μm or less is present is evaluated as “presence of defect”, and the case in which such a line is not present is evaluated as “absence of defect”.

Further, evaluation of the conductivity of the comb-shaped wiring (formation pattern) was conducted by verifying the conductivity (electrical conductivity) of the obtained formation pattern using a continuity tester (ELESTER ET2010, manufactured by AIDEN CO., LTD.).

The formation pattern obtained as described above and the result of the measurement of conductivity were evaluated together according to the following criteria. The evaluation results are shown in Table 1.

(Evaluation Criteria)

A: there is no defect in the comb-shaped wiring, and the conductivity is good.

B: there is a slight defect in the comb-shaped wiring, but the conductivity is good.

C: there is a defect in the comb-shaped wiring, and the conductivity is not good.

TABLE 1

| | | Ink 1 | Ink 2 | Ink 3 | Ink 4 |
|---|---|---|---|---|---|
| Monomer having an | M-6 | 45% | | | |
| interactive group | M-3 | | 45% | | |
| (first monomer) | M-15 | | | 45% | |
| | M-10 | | | | 45% |
| | M-9 | | | | |
| Polyfunctional monomer | Dipropylene glycol | 10% | 10% | 10% | 10% |
| (second monomer) | diacrylate bifunctional | | | | |
| | Diethylene glycol diacrylate | | | | |
| | bifunctional | | | | |
| | Pentaerythritol tetraacrylate | | | | |
| | tetrafunctional | | | | |
| Other monofunctional | Phenoxyethyl acrylate | 40% | 40% | 40% | 40% |
| monomer (third monomer) | | | | | |
| Polymerization initiator | 1-Hydroxy-cyclohexyl | 1.80% | 1.80% | 1.80% | 1.80% |
| | phenyl ketone | | | | |
| | TPO | 3% | 3% | 3% | 3% |
| Surfactant | BYK-307 | 0.20% | 0.20% | 0.20% | 0.20% |
| | BYK-323 | | | | |
| | F-781F | | | | |
| Solvent | Cyclohexanone | | | | |
| | Acetone | | | | |
| | Propylene carbonate | | | | |
| Total monomer content in ink composition (% by mass) | | 95% | 95% | 95% | 95% |
| Content of polymerizable groups possessed by the | | 0.8 | 0.8 | 0.8 | 0.8 |
| polyfunctional monomer (second monomer) in the ink | | | | | |
| composition (mmol/g) | | | | | |
| Proportion of the polyfunctional monomer (second | | 10.50% | 10.50% | 10.50% | 10.50% |
| monomer) relative to whole monomer (% by mass) | | | | | |
| Evaluation results | Ejection recoverability after | A | A | A | A |
| | leaving | | | | |
| | Etching resistance | A | A | A | A |
| | | Ink 5 | Ink 6 | Ink 7 | Ink 8 |
| Monomer having an | M-6 | | 45% | 35% | 35% |
| interactive group | M-3 | | | | 25% |
| (first monomer) | M-15 | | | | |
| | M-10 | | | | |
| | M-9 | 45% | | | |
| Polyfunctional monomer | Dipropylene glycol | 10% | 5% | | |
| (second monomer) | diacrylate bifunctional | | | | |
| | Diethylene glycol diacrylate | | | 10% | 10% |
| | bifunctional | | | | |
| | Pentaerythritol tetraacrylate | | | | |
| | tetrafunctional | | | | |
| Other monofunctional | Phenoxyethyl acrylate | 40% | 45% | 50% | 25% |
| monomer (third monomer) | | | | | |
| Polymerization initiator | 1-Hydroxy-cyclohexyl | 1.80% | 1.80% | 1.80% | 1.80% |
| | phenyl ketone | | | | |
| | TPO | 3% | 3% | 3% | 3% |
| Surfactant | BYK-307 | 0.20% | 0.20% | 0.20% | |
| | BYK-323 | | | | 0.20% |
| | F-781F | | | | |
| Solvent | Cyclohexanone | | | | |
| | Acetone | | | | |
| | Propylene carbonate | | | | |
| Total monomer content in ink composition (% by mass) | | 95% | 95% | 95% | 95% |
| Content of polymerizable groups possessed by the | | 0.8 | 0.4 | 0.9 | 0.9 |
| polyfunctional monomer (second monomer) in the ink | | | | | |
| composition (mmol/g) | | | | | |
| Proportion of the polyfunctional monomer (second | | 10.50% | 5.30% | 10.50% | 10.50% |
| monomer) relative to whole monomer (% by mass) | | | | | |
| Evaluation results | Ejection recoverability after | A | A | A | A |
| | leaving | | | | |
| | Etching resistance | A | B | A | A |
| | | Ink 9 | Ink 10 | Ink 11 | Ink 12 |
| Monomer having an | M-6 | 40% | | | 45% |
| interactive group | M-3 | | | | |
| (first monomer) | M-15 | | 35% | 35% | |
| | M-10 | | | | |
| | M-9 | | | | |
| Polyfunctional monomer | Dipropylene glycol | | 10% | 10% | |
| (second monomer) | diacrylate bifunctional | | | | |
| | Diethylene glycol diacrylate | 10% | | | |
| | bifunctional | | | | |
| | Pentaerythritol tetraacrylate | | | | 18% |
| | tetrafunctional | | | | |
| Other monofunctional | Phenoxyethyl acrylate | 37% | 42% | 42% | 32% |
| monomer (third monomer) | | | | | |
| Polymerization initiator | 1-Hydroxy-cyclohexyl | 1.90% | 1.80% | 1.80% | 1.80% |
| | phenyl ketone | | | | |
| | TPO | 3% | 3% | 3% | 3% |
| Surfactant | BYK-307 | | 0.20% | 0.20% | 0.20% |
| | BYK-323 | | | | |
| | F-781F | 0.10% | | | |
| Solvent | Cyclohexanone | 8% | | | |
| | Acetone | | 8% | | |
| | Propylene carbonate | | | 8% | |
| Total monomer content in ink composition (% by mass) | | 87% | 87% | 87% | 95% |
| Content of polymerizable groups possessed by the | | 0.9 | 0.8 | 0.8 | 2 |
| polyfunctional monomer (second monomer) in the ink | | | | | |
| composition (mmol/g) | | | | | |
| Proportion of the polyfunctional monomer (second | | 11.50% | 11.50% | 11.50% | 18.90% |
| monomer) relative to whole monomer (% by mass) | | | | | |
| Evaluation results | Ejection recoverability after | A | A | A | A |
| | leaving | | | | |
| | Etching resistance | B | A | B | A |

| | | | Comparative |
|---|---|---|---|
| | | Ink 13 | Ink 1 |
| Monomer having an | M-6 | 40% | 40% |
| interactive group | M-3 | 40% | |
| (first monomer) | M-15 | | |
| | M-10 | | |
| | M-9 | | |
| Polyfunctional monomer | Dipropylene glycol | 15% | 10% |
| (second monomer) | diacrylate bifunctional | | |
| | Diethylene glycol diacrylate | | |
| | bifunctional | | |
| | Pentaerythritol tetraacrylate | | |
| | tetrafunctional | | |
| Other monofunctional | Phenoxyethyl acrylate | | 30% |
| monomer (third monomer) | | | |
| Polymerization initiator | 1-Hydroxy-cyclohexyl | 1.80% | 1.80% |
| | phenyl ketone | | |
| | TPO | 3% | 3% |
| Surfactant | BYK-307 | 0.20% | 0.20% |
| | BYK-323 | | |
| | F-781F | | |
| Solvent | Cyclohexanone | | 15% |
| | Acetone | | |
| | Propylene carbonate | | |
| Total monomer content in ink composition (% by mass) | | 95% | 80% |
| Content of polymerizable groups possessed by the | | 1.2 | 0.8 |
| polyfunctional monomer (second monomer) in the ink | | | |
| composition (mmol/g) | | | |
| Proportion of the polyfunctional monomer (second | | 15.80% | 12.50% |
| monomer) relative to whole monomer (% by mass) | | | |
| Evaluation results | Ejection recoverability after | A | C |
| | leaving | | |
| | Etching resistance | A | B |
| | | Comparative | Comparative |
| | | Ink 2 | Ink 3 |
| Monomer having an | M-6 | 45% | |
| interactive group | M-3 | | 45% |
| (first monomer) | M-15 | | |
| | M-10 | | |
| | M-9 | | |
| Polyfunctional monomer | Dipropylene glycol | | 10% |
| (second monomer) | diacrylate bifunctional | | |
| | Diethylene glycol diacrylate | | |
| | bifunctional | | |
| | Pentaerythritol tetraacrylate | | |
| | tetrafunctional | | |
| Other monofunctional | Phenoxyethyl acrylate | 35% | 25% |
| monomer (third monomer) | | | |
| Polymerization initiator | 1-Hydroxy-cyclohexyl | 1.80% | 1.80% |
| | phenyl ketone | | |
| | TPO | 3% | 3% |
| Surfactant | BYK-307 | 0.20% | 0.20% |
| | BYK-323 | | |
| | F-781F | | |
| Solvent | Cyclohexanone | 15% | 15% |
| | Acetone | | |
| | Propylene carbonate | | |
| Total monomer content in ink composition (% by mass) | | 80% | 80% |
| Content of polymerizable groups possessed by the | | 0 | 0.8 |
| polyfunctional monomer (second monomer) in the ink | | | |
| composition (mmol/g) | | | |
| Proportion of the polyfunctional monomer (second | | 0.00% | 12.50% |
| monomer) relative to whole monomer (% by mass) | | | |
| Evaluation results | Ejection recoverability after | C | C |
| | leaving | | |
| | Etching resistance | C | B |

In Table 1 above, the examples using the Inks 1 to 13 are Examples of the present invention, and the examples using the Comparative Inks 1 to 3 are Comparative Examples.

—Evaluation of Etching Resistance under Different Exposure Condition—

Formation of a solid metal film (copper-plated film) was conducted in the same manner as that in the solid drawing described above except that, in the solid drawing described above, Ink 6 described in Table 1 was used, and light exposure in the preparation of a cured film using the Ink 6 was carried out in an environment having an oxygen concentration shown in Table 2 below, and evaluation of etching resistance was performed in the same manner as that in the solid drawing described above.

Here, the adjustment of oxygen concentration was conducted using a nitrogen-purged compact UV irradiation system “CSN2-40” (manufactured by GS Yuasa International Ltd.).

The results of evaluation of the etching resistance in each oxygen concentration are shown in the following Table 2 (the examples of oxygen concentration are all Examples of the present invention).

TABLE 2

| | Oxygen Concentration | | | |
|---|---|---|---|---|
| Evaluation Criteria | 20% | 15% | 10% | 5% |
| Etching Resistance | B | B | A | A |

As shown in Table 1 and Table 2 above, in the Examples, an excellent effect was obtained in the ejection stability (recoverability after leaving) in a case in which ejection of the ink composition by using an inkjet recording apparatus is suspended, and the inkjet recording apparatus is left for a certain period, and then the ejection is resumed, and also the etching resistance was high, and thus, the accuracy of the metal pattern shape obtained was improved.

The disclosure of Japanese Patent Application No. 2010-219421 is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. A method for manufacturing a metal film material, the method comprising:
applying an ink composition by discharging the ink composition onto a substrate via an inkjet method, the ink composition containing at least one first monomer having at least one group selected from the group consisting of a cyano group, an alkyloxy group, an amino group, a pyridine residue, a pyrrolidone residue, an imidazole residue, an alkylsulfanyl group, and a cyclic ether residue, at least one second monomer that has polyfunctionality, and at least one polymerization initiator, a total monomer content in the ink composition being 85% by mass or greater;
forming a cured film by carrying out at least one of light exposure or heating of the ink composition that has been applied;
applying a plating catalyst or a precursor thereof to the cured film; and
performing plating with respect to the plating catalyst or precursor thereof that has been applied.

2. The method for manufacturing a metal film material according to claim 1, wherein the at least one first monomer comprises a monofunctional monomer.

3. The method for manufacturing a metal film material according to claim 1, wherein the at least one first monomer comprises a monomer represented by the following Formula (M1-1): 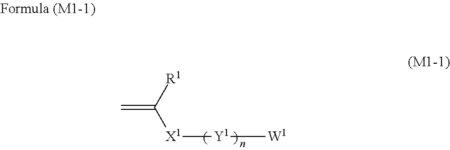
wherein, in Formula (M1-1), R¹ represents a hydrogen atom, or a substituted or unsubstituted alkyl group; X¹ and Y¹ each independently represent a single bond, or a substituted or unsubstituted divalent organic group; W¹ represents a cyano group, an alkyloxy group, an amino group, a pyridine residue, a pyrrolidone residue, an imidazole residue, an alkylsulfanyl group, or a cyclic ether residue; n represents an integer from 1 to 3, and when n is 2 or greater, plural instances of Y¹ may be the same as or different from each other.

4. The method for manufacturing a metal film material according to claim 1, wherein the content of the at least one second monomer is from 1% by mass to 20% by mass with respect to the total amount of monomers included in the ink composition.

5. The method for manufacturing a metal film material according to claim 1, wherein the content of the at least one first monomer is from 10% by mass to 80% by mass with respect to the total amount of monomers included in the ink composition.

6. The method for manufacturing a metal film material according to claim 1, wherein the content of the at least one polymerization initiator is from 1% by mass to 15% by mass with respect to the total amount of the ink composition.

7. The method for manufacturing a metal film material according to claim 1, wherein a content of polymerizable groups included in the at least one second monomer is from 0.5 mmol/g to 2.0 mmol/g, with respect to the total amount of the ink composition.

8. The method for manufacturing a metal film material according to claim 1, wherein a content of polymer compounds having a molecular weight of equal to or greater than 1500 in the ink composition is 2.5% by mass or less.

9. The method for manufacturing a metal film material according to claim 3, wherein, in Formula (M1-1), R¹ represents a hydrogen atom or a methyl group, X¹ represents —COO— or —CONH—, and Y¹ represent an alkylene group having from 1 to 3 carbon atoms.

10. The method for manufacturing a metal film material according to claim 1, wherein the at least one second monomer comprises a polyfunctional monomer having two or more groups selected from the group consisting of acrylate groups, methacrylate groups, acrylamido groups, methacrylamido groups, vinyloxy groups, and N-vinyl groups.

11. The method for manufacturing a metal film material according to claim 1, wherein the formation of the cured film is carried out in an environment having an oxygen concentration of 10% or less.

12. The method for manufacturing a metal film material according to claim 1, wherein, in the application of the ink composition, the ink composition is discharged onto the substrate pattern-wise.

13. A metal film material obtained by the method for manufacturing a metal film material according to claim 1.
